(19) United States
(12) Patent Application Publication
(10) Pub. No.: US 2026/0163004 A1
(43) Pub. Date: Jun. 11, 2026

(54) POSITIVE ELECTRODE FOR LITHIUM SECONDARY BATTERY AND LITHIUM SECONDARY BATTERY USING THE SAME

(71) Applicant: KOREA ELECTRONICS TECHNOLOGY INSTITUTE, Seongnam-si (KR)

(72) Inventors: Sanggil WOO, Seongnam-si (KR); Je-Nam LEE, Seongnam-si (KR); So Young NAM, Seongnam-si (KR)

(21) Appl. No.: 19/415,288

(22) Filed: Dec. 10, 2025

(30) Foreign Application Priority Data
Dec. 11, 2024 (KR) 10-2024-0183861
Mar. 11, 2025 (KR) 10-2025-0031719

(51) Int. Cl. H01M 4/62; H01M 4/02; H01M 4/505; H01M 4/525; H01M 10/0525

(52) U.S. Cl. CPC H01M 4/623; H01M 4/505; H01M 4/525; H01M 10/0525; H01M 2004/028

(57) ABSTRACT

Disclosed is a positive electrode for a lithium secondary battery and to a lithium secondary battery using the same, which have improved wetting properties by coating a binder constituting a positive electrode with an ethylene monomer-containing copolymer. A positive electrode according to the present invention includes a current collector, and a positive electrode material disposed on at least one surface of the current collector, wherein the positive electrode material includes a positive electrode active material, a fluorinated binder, and a conductive material and has a contact angle of 50° or less with respect to an electrolyte.

### CROSS REFERENCE TO RELATED APPLICATION

The present application claims priority to Korean Patent Application No. 10-2024-0183861, filed Dec. 11, 2024, and Korean Patent Application No. 10-2025-0031719, filed Mar. 11, 2025, the contents of which are incorporated herein by reference in their entirety.

### BACKGROUND OF THE INVENTION

### Field of the Invention

The present invention relates to a positive electrode for a lithium secondary battery and to a lithium secondary battery using the same, which have improved wettability by coating a binder constituting a positive electrode with an ethylene monomer-containing copolymer.

### Description of the Related Art

A positive electrode constituting a secondary battery includes a current collector and a positive electrode material, and the positive electrode material includes a positive electrode active material, a binder, and a conductive material.

The positive electrode can use a lithium transition metal oxide-based positive electrode active material and can be manufactured by a series of processes of mixing a binder, typically polyvinylidene fluoride (PVDF), and a carbon-based conductive material with an organic solvent, typically N-methyl pyrrolidone (NMP), and then coating, drying, and rolling the mixture on an aluminum substrate.

However, there occur a problem that the toxicity of the organic solvent, NMP, requires a recovery process, a problem that the migration of the binder during an electrode drying process makes it difficult to produce thick electrodes, a problem that NMP evaporates, creating defects such as cracks, and a problem that high thermal energy costs associated with evaporating NMP are significant.

As an alternative technology for solving such problems, active research is being conducted on solvent-free electrode manufacturing methods.

A representative solvent-free electrode manufacturing method uses a solvent-insoluble polytetrafluoroethylene (PTFE) binder instead of a PVDF binder in the positive electrode.

This method manufactures an electrode by mixing electrode components and inducing fiberization of the PTFE binder through a kneading process of kneading the resulting mixture at a high temperature under a pressure higher than or equal to atmospheric pressure, and a milling process.

However, the PTFE binder, which is a hydrophobic polymer, has poor compatibility with an electrolyte used in lithium secondary batteries, leading to ongoing concerns about electrolyte impregnation properties.

Accordingly, there is a need for research to improve the wettability of the binder constituting the positive electrode, thereby maintaining or enhancing the electrical properties of lithium secondary batteries.

### SUMMARY OF THE INVENTION

The present invention is directed to providing a positive electrode for a lithium secondary battery and a lithium secondary battery using the same, which have improved wettability by coating a binder constituting a positive electrode with an ethylene monomer-containing copolymer.

In addition, the present invention is directed to providing a positive electrode for a lithium secondary battery and a lithium secondary battery using the same, which may stably maintain capacity and lifetime characteristics.

Objects of the present invention are not limited to the above object, and other objects and advantages of the present invention which are not mentioned can be understood by the following description and more clearly understood by various embodiments of the present disclosure. In addition, it will be able to be easily seen that the objects and advantages of the present invention may be achieved by devices and combinations thereof that are described in the claims.

According to the present invention, there is provided a positive electrode including a current collector, and a positive electrode material disposed on at least one surface of the current collector, wherein the positive electrode material includes a positive electrode active material, a fluorinated binder, and a conductive material and has a contact angle of 50° or less with respect to an electrolyte.

The fluorinated binder may include a polytetramethylene fluoride (PTEF) binder.

The fluorinated binder may include an ethylene monomer-containing copolymer.

The fluorinated binder may include an ethylene monomer-containing copolymer at 0.3 to 100 parts by weight based on 100 parts by weight of a PTEF binder.

A weight average molecular weight of the ethylene monomer-containing copolymer may range from 1000 to 150×10⁴ g/mol.

The ethylene monomer-containing copolymer may include one or more of an ethylene vinyl acetate (EVA)-based copolymer, poly(ethylene-co-acrylic acid) (PEAA), ethylene vinyl alcohol (EVOH), and poly(ethylene-co-ethyl acrylate) (PEEA).

The EVA-based copolymer may have a content of the ethylene monomer higher than that of a vinyl acetate monomer.

The EVA-based copolymer may include the ethylene monomer at 20 to 80 wt % and the vinyl acetate monomer at 20 to 80 wt %.

The positive electrode active material may include one or more lithium transition metal oxides selected from the group consisting of lithium cobalt oxide, lithium nickel oxide, lithium nickel cobalt oxide, lithium nickel cobalt aluminum oxide, lithium nickel cobalt manganese oxide, lithium manganese oxide, and lithium iron phosphate oxide.

According to the present invention, there is provided a lithium secondary battery including a positive electrode, a negative electrode, and an electrolyte, wherein the positive electrode includes a current collector, and a positive electrode material disposed on at least one surface of the current collector, and the positive electrode material includes a positive electrode active material, a fluorinated binder, and a conductive material and has a contact angle of 50° or less with respect to the electrolyte.

The fluorinated binder may include a polytetramethylene fluoride (PTEF) binder.

The fluorinated binder may include an ethylene monomer-containing copolymer.

The positive electrode according to the present invention can be manufactured by coating the hydrophobic binder with the ethylene monomer-containing copolymer, thereby maintaining the binding properties and improving wettability of the binder.

Accordingly, the positive electrode can exhibit electrolyte impregnation properties and stably maintain or improve the capacity and lifetime characteristics of the lithium secondary battery including the positive electrode.

Specific effects together with the above effects are described together with a description of the following detailed matters for carrying out the disclosure.

### BRIEF DESCRIPTION OF THE DRAWINGS

FIG. 1 illustrates the results of evaluating the electrochemical properties of a positive electrode to which binders of Examples 1 to 5 and Comparative Examples 1 and 2 according to the present invention were applied.

### DETAILED DESCRIPTION OF THE INVENTION

The above-described objects, features, and advantages will be described below in detail with reference to the accompanying drawings, and thus those skilled in the art to which the present disclosure pertains will be able to easily carry out the technical spirit of the present disclosure. In describing the present invention, when it is determined that a detailed description of the known technology related to the present invention may unnecessarily obscure the gist of the present invention, a detailed description thereof will be omitted. Hereinafter, exemplary embodiments according to the present invention will be described in detail with reference to the accompanying drawings. In the drawings, the same reference numerals are used to denote the same or similar components.

Hereinafter, the arrangement of an arbitrary component on an “upper portion (or lower portion)” of a component or “above (or under)” the component may not only mean that the arbitrary component is disposed in contact with an upper surface (or a lower surface) of the component, but also mean that other components may be interposed between the component and the arbitrary component disposed above (or under) the component.

In addition, when a first component is described as being “connected,” “coupled,” or “joined” to a second component, the components may be directly connected or joined, but it should be understood that a third component may be “interposed” between the components, or the components may be “connected,” “coupled,” or “joined” through the third component.

Hereinafter, a positive electrode for a lithium secondary battery and a lithium secondary battery using the same according to some embodiments of the present invention will be described.

A binder constituting a positive electrode functions to bind a positive electrode active material and a conductive material.

During a dry manufacturing process of a solvent-free positive electrode, PTFE is used as a binder alone or mixed with PVDF, but this method has the disadvantages of requiring an increased content of the binder and requiring electrode manufacturing at a high temperature higher than or equal to 150° C.

Accordingly, the inventors of the present invention have studied coating a polytetramethylene fluoride (PTEF) binder with an ethylene monomer-containing copolymer in a positive electrode, thereby demonstrating the improved wettability of the binder and electrolyte impregnation properties, and as a result, the inventors experimentally confirmed that the capacity and lifetime characteristics of a lithium secondary battery were stably maintained or enhanced.

In addition, the method of coating a PTEF binder with an ethylene monomer-containing copolymer according to the present invention has the advantage of maintaining the dry manufacturing process for the positive electrode.

The positive electrode according to the present invention includes a current collector and a positive electrode material disposed on at least one surface of the current collector, in which the positive electrode material includes a positive electrode active material, a fluorinated binder, and a conductive material, and has a contact angle of 50° or less with respect to an electrolyte.

The current collector of the positive electrode functions to collect electrons generated by an electrochemical reaction of the positive electrode or supply electrons necessary for the electrochemical reaction.

The current collector of the positive electrode may include a material having high conductivity without causing chemical changes in a battery. For example, the current collector of the positive electrode may be made of stainless steel, aluminum, nickel, titanium, calcined carbon, etc., and aluminum or stainless steel may be surface-treated with carbon, nickel, titanium, silver, etc.

In addition, the current collector of the positive electrode may form fine uneven patterns on a surface thereof to enhance the adhesion of the positive electrode active material and have various forms, such as a film, sheet, foil, net, porous body, foam, non-woven fabric, etc.

In addition, an average thickness of the current collector of the positive electrode may range from 3 to 500 μm in consideration of the conductivity and total thickness of the manufactured positive electrode.

The positive electrode material may include a positive electrode active material, a fluorinated binder, and a conductive agent to enhance electronic conductivity.

First, the fluorinated binder functions to bind the positive electrode active material and the conductive agent and physically connects the mixture during the mixing process of the positive electrode active material, the fluorinated binder, and the conductive agent during electrode manufacturing.

In the present invention, the fluorinated binder was selected for the dry manufacturing process of the positive electrode.

The dry manufacturing process of the solvent-free positive electrode may be performed as follows.

First, a PTEF binder coated with an ethylene monomer-containing copolymer and the active material conductive agent may be mixed in an appropriate ratio.

The mixed mixture may be stirred using a kneader or extruder to form a dough (mixture dough), which may then be finely ground at 10,000 to 20,000 RPM.

The ground mixture dough may be pressed to an appropriate thickness using a 3R roll press.

Roll pressing is performed to adjust a thickness of the ground mixture dough.

The roll pressing is performed to bind the ground mixture dough and the current collector.

The fluorinated binder may include a PTEF binder.

The PTEF binder, which is a hydrophobic polymer, needs to have electrolyte impregnation properties and electrode wettability accordingly.

The term “hydrophobic” refers to a region that cannot be easily coupled with water molecules. Hydrophobicity may be determined through the contact angle, which is an angle formed when a liquid reaches thermodynamic equilibrium on a solid surface.

That is, the contact angle is defined as an angle formed by a tangent line drawn from a point of contact between the solid surface and the liquid to the liquid surface and the solid surface. The angle represents a measure of the wettability of the solid surface and is typically measured using a sessile drop.

By controlling the wettability of the fluorinated binder constituting the positive electrode, the impregnation with the electrolyte can be improved, thereby stably maintaining the capacity and lifetime characteristics of lithium secondary batteries.

From this perspective, the positive electrode preferably has a contact angle of 50° or less between the surface of the positive electrode material and the electrolyte, and more preferably from over 0° to 45° or less.

By satisfying the contact angle between the surface of the positive electrode material and the electrolyte in a range of 50° or less, the wettability of the fluorinated binder can be improved.

In the present invention, to control the wettability of the fluorinated binder, a coating component, an ethylene monomer-containing copolymer, was mixed with the fluorinated binder to modify, treat, or coat the surface of the fluorinated binder.

The coating component is soluble in the organic solvent constituting the electrolyte, and the ethylene monomer-containing copolymer may include one or more of an ethylene vinyl acetate (EVA) copolymer, poly(ethylene-co-acrylic acid) (PEAA), ethylene vinyl alcohol (EVOH), and poly(ethylene-co-ethyl acrylate) (PEEA).

Specifically, the ethylene monomer-containing copolymer may include polyethylene vinyl acetate (PEVA).

Since the ethylene monomer-containing copolymer was mixed with the fluorinated binder, the fluorinated binder has the form of the ethylene monomer-containing copolymer.

The fluorinated binder may contain an ethylene monomer-containing copolymer at 0.3 to 100 parts by weight, preferably at 0.3 to 20 parts by weight, more preferably at 0.3 to 10 parts by weight, and even more preferably 1 to 5 parts by weight based on 100 parts by weight of a PTEF binder.

In addition, the fluorinated binder may contain the ethylene monomer-containing copolymer at 1 to 3 parts by weight.

In the fluorinated binder, the content of the ethylene monomer-containing copolymer satisfies 0.3 to 100 parts by weight, which has an advantageous effect in improving the wettability of the electrode.

In particular, in the fluorinated binder, the content of the ethylene monomer-containing copolymer is 1 to 5 parts by weight, which can effectively maintain the wettability of the electrode and the capacity and lifetime characteristics of lithium secondary batteries.

When the content of the ethylene monomer-containing copolymer is less than 0.3 parts by weight, the ethylene monomer-containing copolymer may not be sufficiently coated onto the fluorinated binder, and thus the advantageous effects of the ethylene monomer-containing copolymer cannot be realized.

Conversely, when the content of the ethylene monomer-containing copolymer exceeds 100 parts by weight, the electrode properties deteriorate, and a resistive film may be formed in the pore structure and the positive electrode structure.

A weight-average molecular weight of the ethylene monomer-containing copolymer may range from 1000 to 150×10⁴ g/mol, preferably 10,000 to 50×10⁴ g/mol, more preferably 20,000 to 30×10⁴ g/mol, and even more preferably 40,000 to 20×10⁴ g/mol.

By ensuring that the weight-average molecular weight of the ethylene monomer-containing copolymer satisfies 1000 to 150×10⁴ g/mol, sufficient binding properties can be achieved, which can be advantageous in improving the electrical properties of the positive electrode including the binder.

When the weight-average molecular weight of the ethylene monomer-containing copolymer is less than 1000 g/mol, the binding properties can be weak, and thus a coating layer of the ethylene monomer-containing copolymer in the fluorinated binder cannot be maintained and peeled off.

The ethylene monomer-containing copolymer, which is the coating component, may include an ethylene vinyl acetate (EVA)-based copolymer.

The EVA-based copolymer preferably includes both an ethylene monomer and a vinyl acetate (VA) monomer.

When the coating component includes only the VA monomer, the electrical properties of the positive electrode may deteriorate at high temperatures, but the wettability of the positive electrode can be enhanced.

From this perspective, the EVA-based copolymer preferably has a content of the ethylene monomer higher than that of the VA monomer.

The EVA-based copolymer may contain an ethylene monomer at 20 to 80 wt % and a VA monomer at 20 to 80 wt %, preferably 30 to 80 wt % and 20 to 70 wt %, and more preferably 35 to 75 wt % and 25 to 65 wt %.

By ensuring that the EVA-based copolymer satisfies an ethylene monomer at 20 to 80 wt % and a VA monomer at 20 to 80 wt %, it is possible to enhance both the wettability and electrical properties, such as capacity and lifetime characteristics, of the positive electrode.

The positive electrode material may contain a fluorinated binder at 0.5 to 10 wt % based on the total 100 wt % of the positive electrode active material, the fluorinated binder, and the conductive material.

When the content of the fluorinated binder exceeds 10 wt %, excessive fiberization of the binder can adversely affect the process.

Conversely, when the content of the fluorinated binder is less than 0.5 wt %, sufficient binding properties cannot be achieved, resulting in poor cohesion to the point of forming lumps or deteriorating electrode properties.

In addition to the fluorinated binder, the positive electrode material may further include additional binders, such as a polyethylene oxide (PEO) binder, a PVDF binder, a polyvinylidene fluoride-hexafluoropropylene (PVDF-HFP) binder, an ethylene propylene diene polymer (EPDM) binder, an acetonitrile butadiene (AB) binder, a polyisoprene binder, a polybutadiene binder, a polyvinylpyrrolidone (PVP) binder, a polyacrylate binder, a polyurethane binder, an epoxy binder, a polyester binder, a silicon binder, a polyamide binder, etc., but is not limited thereto.

The positive electrode active material may be any material capable of absorbing and releasing lithium ions in addition to lithium.

For example, the positive electrode active material may be at least one of a layered compound such as lithium cobalt oxide (LiCoO₂), lithium nickel oxide (LiNiO₂), etc., or a compound substituted with one or more transition metals; lithium manganese oxides, such as LiMnO₃, LiMn₂O₃, LiMnO₂, etc., represented by Chemical Formula Li₁₊ₓMn₂₋ₓO₄ (where x is 0 to 0.33); lithium copper oxide (Li₂CuO₂); vanadium oxides such as LiV₃O₈, LiV₃O₄, V₂O₅, and Cu₂V₂O₇; Ni site type lithium nickel oxides represented by Chemical Formula LiNi₁₋ₓMₓO₂ (where M=Co, Mn, Al, Cu, Fe, Mg, B or Ga and x=0.01 to 0.3); lithium manganese complex oxide represented by Chemical Formula LiMn₁₋ₓMₓO₂ (where M=Co, Ni, Fe, Cr, Zn or Ta, and x=0.01 to 0.1) or Li₂Mn₃MO₈ (where M=Fe, Co, Ni, Cu or Zn); a lithium manganese composite oxide having a spinel structure represented by LiNiₓMn₂₋ₓO₄; LiMn₂O₄ in which a portion of Li in Chemical Formula is substituted with an alkaline earth metal ion; disulfide compounds; Fe₂(MoO₄)₃, etc.

Preferably, the positive electrode active material may include one or more lithium transition metal oxides selected from the group consisting of lithium cobalt oxide, lithium nickel oxide, lithium nickel cobalt oxide, lithium nickel cobalt aluminum oxide, lithium nickel cobalt manganese oxide, lithium manganese oxide, and lithium iron phosphate oxide.

The positive electrode material may include the positive electrode active material at 80 to 98.5 wt % based on 100 wt % of the positive electrode active material, the fluorinated binder, and the conductive agent, but is not limited thereto.

The conductive agent may include one or more of activated carbon, natural graphite, artificial graphite, carbon black, acetylene black, Denka black, Ketjen black, super-P, channel black, furnace black, lamp black, thermal black, graphene, and carbon nanotubes.

The positive electrode material may include the conductive material at 0.5 to 5 wt % based on 100 wt % of the positive electrode active material, the fluorinated binder, and the conductive agent, but is not limited thereto.

### Lithium Secondary Battery

A lithium secondary battery according to the present invention includes a positive electrode, a negative electrode, and an electrolyte.

The positive electrode includes a current collector and a positive electrode material disposed on at least one surface of the current collector, in which the positive electrode material includes a positive electrode active material, a fluorinated binder, and a conductive material, and has a contact angle of 50° or less with respect to an electrolyte.

As described above, the fluorinated binder may include a PTEF binder.

In addition, to enhance the wettability of the fluorinated binder, an ethylene monomer-containing copolymer, which is a coating component, may be included.

The positive electrode material is the same as described above and thus will be omitted.

A negative electrode may functionally generate and consume electrons through an electrochemical reaction and provide electrons to an external circuit through a negative electrode current collector.

The negative electrode may reversibly intercalate or deintercalate lithium ions.

The negative electrode may include a current collector and a negative electrode material disposed on at least one surface of the current collector and including a negative electrode active material.

The negative electrode current collector may be made of a material that does not react with lithium, that is, does not form an alloy or compound.

The negative electrode current collector may include, for example, one or more selected from the group consisting of copper (Cu), stainless steel, titanium (Ti), iron (Fe), cobalt (Co), and nickel (Ni).

The negative electrode current collector may be made of one metal, including the above examples or made of an alloy or clad material of two or more metals.

The negative electrode current collector may be, for example, plate-shaped or foil-shaped.

The negative electrode material may include lithium metal.

In this case, large-scale lithium ion release is possible, significantly improving battery performance.

The positive and negative electrodes may be wound in a jellyroll shape and stored in a cylindrical battery, a prismatic battery, or a pouch-type battery or stored in the pouch-type battery in a folding or stack-and-folding manner, but are not limited thereto.

The electrolyte functions to dissolve lithium, which is used as the negative electrode material, in an organic solvent and dissociating into ions to conduct electric current.

The electrolyte includes a lithium salt and an organic solvent.

Examples of the lithium salt may include LiPF₆, LiBF₄, LiClO₄, LITFSI, LiNO₃, LiCF₃SO₃, LiAsF₆, LiN(CF₃SO₂)₂, LiN(C₂F₅SO₂)₂, LiTDI, etc.

Examples of the organic solvent may include polar solvents, such as aryl compounds, bicyclic ethers, acyclic carbonates, sulfoxide compounds, lactone compounds, ketone compounds, ester compounds, sulfate compounds, sulfite compounds, etc.

Examples of the electrolyte solvent may include dimethoxyethane (DME), dioxolane (DOL), trimethylene glycol dimethyl ether (TEGDME), diethylene glycol dimethyl ether (DEGDME), etc., but are not limited thereto.

A separator is a component interposed between the negative electrode and the positive electrode to prevent direct contact and short circuit therebetween. The separator functions to not only physically separate the negative electrode and the positive electrode, but also improve the stability of the battery.

The separator may be a porous sheet, nonwoven fabric, etc., and may be a multilayer film including two or more layers of polyethylene, polypropylene, or polyvinylidene fluoride, a mixed multilayer film including two layers of polyethylene/polypropylene, a mixed multilayer film including three layers of polyethylene/polypropylene/polyethylene, or a mixed multilayer film including three layers of polypropylene/polyethylene/polypropylene, and may also have a porous heat-resistant layer formed on one surface or both surfaces of the porous sheet, the nonwoven fabric, etc.

The separator is not particularly limited, but may have a thickness of 10 to 40 μm.

Lithium secondary batteries may be used in portable devices, such as a mobile phone, a laptop computer, a digital camera, etc., and electric vehicles, such as a hybrid electric vehicle (HEV) and the like.

Accordingly, a battery module including a lithium secondary battery as a unit cell and a battery pack including the same may be provided.

The battery module or the battery pack may be used as a power source for one or more medium- to large-sized devices, such as a power tool, an EV, a HEV, and a plug-in HEV (PHEV), or a power storage system.

In this way, specific examples of a positive electrode for a lithium secondary battery and a lithium secondary battery using the same will be described as follows.

### 1. Manufacture of Positive Electrode and Lithium Secondary Battery

TABLE 1

| | | | | PEVA |
|---|---|---|---|---|
| | PEVA | | | content |
| | Weight | | | with |
| | average | | Ethylene | respect |
| | molecular | VA content | content of | to PTFE |
| | weight | of PEVA | PEVA | (weight |
| | (Mw; g/mol) | (wt %) | (wt %) | by parts) |
| Example 1 | 138,000 | 28 | 72 | 1.9 |
| Example 2 | 138,000 | 28 | 72 | 10 |
| Example 3 | 350,000 | 28 | 72 | 1.9 |
| Example 4 | 29,000 | 62 | 38 | 1.9 |
| Example 5 | 100,000 | 100 | 0 | 1.9 |
| Example 6 | 138,000 | 28 | 72 | 3 |
| Comparative | — | — | — | 0 (pure |
| Example 1 | | | | PTFE) |
| Comparative | 350,000 | 0 | 100 | 1.9 |
| Example 2 | | | | |
| Comparative | 350,000 | 0 | 100 | 30 |
| Example 3 | | | | |

### Example 1

PEVA (Mw 138,000 g/mol, VA 28 wt %) of 1.9 parts by weight based on 100 parts by weight of a PTFE binder was coated.

### Example 2

The conditions were the same as in Example 1, except that the PEVA coating amount was 10 parts by weight.

### Example 3

The conditions were the same as in Example 1, except that PEVA (Mw 350,000 g/mol) was used.

### Example 4

The conditions were the same as in Example 1, except that PEVA (Mw 29,000 g/mol, VA 62 wt %) was used.

### Example 5

The conditions were the same as in Example 1, except that poly(vinyl acetate) (Mw 100,000 g/mol) consisting of 100% VA was used instead of PEVA.

### Example 6

The conditions were the same as in Example 1, except that the PEVA coating amount was 3 parts by weight.

### Comparative Example 1

An uncoated PTFE binder was used.

### Comparative Example 2

Instead of PEVA, PE (Mw 350,000 g/mol) of 1.9 parts by weight, which consists of 100% ethylene, was used as a simple mixture with PTFE (PE coating was not possible).

### Comparative Example 3

Instead of PEVA, PE (Mw 350,000 g/mol) of 30 parts by weight, which consists of 100% ethylene, was used as a simple mixture with PTFE (PE coating was not possible).

### 2. Physical Property Evaluation Method and its Results

To examine the impregnation properties of the electrolyte, a 1M LiPF₆, EC/DMC (3:7) electrolyte containing FEC at 10 wt % was used to examine the impregnation properties of a polymer.

Electrode sheets were prepared using the binders of Examples 1 to 5 and Comparative Examples 1 and 2 with a weight ratio of 96:2:2 for an active material (NCM811), a conductive material, and a binder, respectively, an electrolyte was dropped onto the electrode sheet, and the contact angle (greater than 0°) of the electrode sheet was measured.

A measurement equipment used was a Phoenix 300 contact angle analyzer.

Table 2 shows the contact angle measurement results of the electrode sheets.

TABLE 2

| | Contact angle |
|---|---|
| | (°) |
| Example 1 | 41 |
| Example 2 | 36 |
| Example 3 | 43 |
| Example 4 | 36 |
| Example 5 | 30 |
| Example 6 | 39 |
| Comparative | 60 |
| Example 1 | |
| Comparative | 58 |
| Example 2 | |
| Comparative | 59 |
| Example 3 | |

As a result, the electrode sheets of Examples 1 to 6 exhibited contact angles of 50° or less.

Conversely, the uncoated PTFE film of Comparative Example 1 exhibited a contact angle of 60°, and the PTFE films mixed with PE, as in Comparative Examples 2 and 3, exhibited contact angles of 58° and 59°, respectively.

Based on these results, it can be confirmed that the electrode sheets of Examples 1 to 6 of the present invention exhibit improved electrolyte impregnation (affinity) compared to the electrode sheets of Comparative Examples 1 to 3.

The same results were observed in the positive electrode state using the electrode sheets of Table 2.

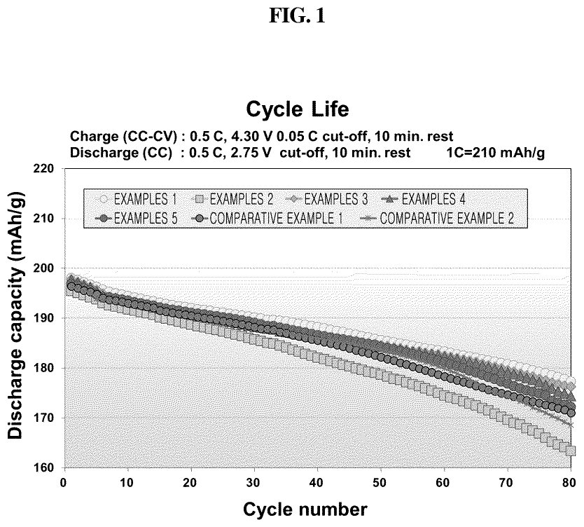

FIG. 1 illustrates the results of evaluating the electrochemical properties of a positive electrode to which binders of Examples 1 to 5 and Comparative Examples 1 and 2 according to the present invention were applied.

To examine the electrochemical properties, electrodes were manufactured using the above binders.

A positive electrode, which has a weight ratio of 96:2:2 for an active material (NCM811), the binder, and a conductive material, respectively, and an average electrode loading of 37 mg/cm², was manufactured. The electrolyte used was based on a carbonate-ether composition.

The electrochemical properties of the positive electrode were evaluated using a WBCS3000 automatic battery cycler (WonATech, South Korea).

As described above, the binders used in the experimental tests were those of Examples 1 to 5 and Comparative Examples 1 and 2.

As a result, under 0.5 C and 80 cycles, the discharge capacities of Examples 1 and 3 to 5 were superior to those of Comparative Examples 1 and 2.

In particular, the discharge capacity of Example 1 was the best.

These results indicate that the capacity characteristics of the positive electrode are enhanced as the weight-average molecular weight of PEVA satisfies 110,000 to 200,000 and the VA content of the PEVA is lower than the ethylene content.

Example 2 showed the lowest contact angle in Table 2, while FIG. 1 illustrates that the discharge capacity of Example 2 is lower than that of Example 1.

This appears to be because the capacity of the positive electrode decreased due to the coating of 10 parts by weight of PEVA, which functions as a coating component, in Example 2.

To determine correlation between the contact angle and capacity retention rate of the positive electrode, the following conversion factor (F) was defined

$$Conversion factor ( F ) = \{ ( 180 - contact angle ) \times 0.1 \} + capacity retention rate after 80 cycles of operation .$$

Table 3 shows the capacity retention rate and conversion factor of the positive electrode.

TABLE 3

| | Capacity | |
|---|---|---|
| | retention | Conversion |
| | rate (%) | factor (F) |
| Example 1 | 89.5 | 103.4 |
| Example 2 | 83.6 | 98 |
| Example 3 | 89.3 | 102.9 |
| Example 4 | 88.2 | 102.6 |
| Example 5 | 87.5 | 102.5 |
| Example 6 | 88.0 | 102.1 |
| Comparative | 87.1 | 99.1 |
| Example 1 | | |
| Comparative | 85.9 | 98.1 |
| Example 2 | | |
| Comparative | 84.8 | 96.9 |
| Example 3 | | |

The results in Table 3 show that the conversion factors of Example 1 and Examples 3 to 6 were greater than or equal to 100, which is higher than those of Comparative Examples 1 to 3.

Specifically, the conversion factors of Examples 1 and Examples 3 to 6 satisfied a range of 102 to 104, and among these, Examples 1, 3, and 4 satisfied a range of 102.6 to 104.

In the conversion factor (F)={(180−contact angle)×0.1}+capacity retention rate after 80 cycles, the reason for limiting the cycle to 80 cycles is that this is the cycle level at which the conversion factor may be measured without being influenced by other factors.

Considering the content ratio of PEVA, the specific composition ratio of PEVA, and the weight-average molecular weight of PEVA, the results of Example 1 showed the best performance in capacity retention rate because it improved the contact angle without affecting the maintenance of the electrode shape.

The term “maintenance of the electrode shape” refers to a state in which the electrode sheet is not broken or disintegrated and no stains are generated due to non-uniform mixing.

To examine the electrochemical rate characteristics of the positive electrodes, the positive electrodes prepared in Examples 1 to 6 and Comparative Examples 1 to 3 were evaluated. The electrolyte used was based on a carbonate-ether composition.

The term “the rate characteristics” refer to the capacity retention characteristics according to the charge/discharge rate.

For the positive electrodes prepared in Examples 1 to 6 and Comparative Examples 1 to 3, the actual capacity compared to the 0.2 C capacity under high current driving conditions of 1 C to 3 C is shown in Table 4.

TABLE 4

| | 1 C | 2 C | 3 C |
|---|---|---|---|
| | capacity/0.2 C | capacity/0.2 C | capacity/0.2 C |
| | capacity | capacity | Capacity |
| | retention rate | retention rate | retention rate |
| | (%) | (%) | (%) |
| Example 1 | 89.3 | 42.8 | 18.5 |
| Example 2 | 87.1 | 36.4 | 13.9 |
| Example 3 | 89.2 | 42.7 | 18.3 |
| Example 4 | 88.5 | 41.2 | 17.4 |
| Example 5 | 87.9 | 39.1 | 16.9 |
| Example 6 | 87.8 | 39.2 | 17.0 |
| Comparative | 87.3 | 38.9 | 16.8 |
| Example 1 | | | |
| Comparative | 86.6 | 38.9 | 16.0 |
| Example 2 | | | |
| Comparative | 85.8 | 36.1 | 12.1 |
| Example 3 | | | |

In Example 1, the realized capacity was maintained at 89.3%, 42.8%, and 18.5% of the initial capacity.

Examples 3 to 6 also exhibited improved rate characteristics compared to Comparative Examples 1 and 2.

In particular, Examples 1, 3, and 4 exhibited excellent rate characteristics, with Example 1 demonstrating the best rate characteristics.

In contrast, in Example 2, the realized capacity was maintained at 87.1%, 36.4%, and 13.9% of the initial capacity, showing inferior characteristics compared to Example 1.

These results indicate that the coating content of an EVA-based copolymer, which is an ethylene monomer-containing copolymer, influences lithium ion transport in the positive electrode.

Although the present invention has been described above with reference to the exemplary drawings, the present invention is not limited by the embodiments and drawings disclosed in the specification, and it is apparent that various modifications can be made by those skilled in the art within the scope of the technical spirit of the present invention. In addition, even when the operational effects according to the configuration of the present invention have not been explicitly described in the description of the embodiments of the present invention, it goes without saying that the effects predictable by the corresponding configuration should be recognized.

What is claimed is:

1. A positive electrode comprising:
a current collector; and
a positive electrode material disposed on at least one surface of the current collector,
wherein the positive electrode material includes a positive electrode active material, a fluorinated binder, and a conductive material, and
has a contact angle of 50° or less with respect to an electrolyte.

2. The positive electrode of claim 1, wherein the fluorinated binder includes a polytetramethylene fluoride (PTEF) binder.

3. The positive electrode of claim 1, wherein the fluorinated binder includes an ethylene monomer-containing copolymer.

4. The positive electrode of claim 1, wherein the fluorinated binder includes an ethylene monomer-containing copolymer at 0.3 to 100 parts by weight based on 100 parts by weight of a PTEF binder.

5. The positive electrode of claim 3, wherein a weight average molecular weight of the ethylene monomer-containing copolymer ranges from 1000 to 150×10⁴ g/mol.

6. The positive electrode of claim 3, wherein the ethylene monomer-containing copolymer includes one or more of an ethylene vinyl acetate (EVA)-based copolymer, poly(ethylene-co-acrylic acid) (PEAA), ethylene vinyl alcohol (EVOH), and poly(ethylene-co-ethyl acrylate) (PEEA).

7. The positive electrode of claim 6, wherein the EVA-based copolymer has a content of the ethylene monomer higher than that of a vinyl acetate monomer.

8. The positive electrode of claim 7, wherein the EVA-based copolymer includes the ethylene monomer at 20 to 80 wt % and the vinyl acetate monomer at 20 to 80 wt %.

9. The positive electrode of claim 1, wherein the positive electrode active material includes one or more lithium transition metal oxides selected from the group consisting of lithium cobalt oxide, lithium nickel oxide, lithium nickel cobalt oxide, lithium nickel cobalt aluminum oxide, lithium nickel cobalt manganese oxide, lithium manganese oxide, and lithium iron phosphate oxide.

10. A lithium secondary battery comprising:
a positive electrode; a negative electrode; and an electrolyte,
wherein the positive electrode includes:
a current collector; and
a positive electrode material disposed on at least one surface of the current collector, and
the positive electrode material includes a positive electrode active material, a fluorinated binder, and a conductive material, and
has a contact angle of 50° or less with respect to the electrolyte.

11. The lithium secondary battery of claim 10, wherein the fluorinated binder includes a polytetramethylene fluoride (PTEF) binder.

12. The lithium secondary battery of claim 10, wherein the fluorinated binder includes an ethylene monomer-containing copolymer.
